(19) United States
(12) Patent Application Publication
(10) Pub. No.: US 2011/0197825 A1
(43) Pub. Date: Aug. 18, 2011

(54) PICK UP TOOL

(76) Inventor: Jonathan JAN, Culver City, CA (US)

(21) Appl. No.: 12/707,440

(22) Filed: Feb. 17, 2010

(51) Int. Cl. A01K 29/00; A47F 13/06; A01K 27/00; B25J 1/04; B25J 1/00

(52) U.S. Cl. 119/795

(57) ABSTRACT

A pick up tool has a handle assembly having a trigger connected to a pull rod. The trigger has a trigger engaged position, and a trigger disengaged position. In the trigger engaged position the trigger pushes the pull rod down, and in the trigger disengaged position, the trigger pulls the pull rod up. A hollow main shaft is mounted to the handle assembly, and the pull rod is housed within the main shaft. A bell housing is mounted to the handle assembly, and the bell housing has an upper bell portion, a middle bell portion, a lower bell portion and a bell flange. A plurality of fingers are connected at a common joint within the bell housing, and the plurality of fingers have an extended position and a retracted position. A liner assembly includes a liner bag having a closed end and a liner rim.

A variety of picking mechanisms have been used for picking up debris such as trash, leaves and droppings. In particular, animal droppings contain parasites and numerous disease-causing microorganisms. As our public becomes aware of environmental hazards and the threat on public health, municipalities have passed ordinances requiring dog walkers to pick up after their dogs. The most common practice is to pick up after dogs by hand with a plastic bag but many find this to be unpleasant.

Pick up tools have been continuously improved, and there appears to have been hundreds of different design improvements over the years. Tittemore in U.S. Pat. No. 7,588,273 issued Sep. 15, 2009 provides a scooper with a bag, which allows collection in an elongated cylindrical member, the disclosure of which is incorporated herein by reference. Azrikam in U.S. Pat. No. 6,983,966 issued Jan. 10, 2006 provides for a pair of jaws and a bag for collection between the jaws, the disclosure of which is incorporated herein by reference. Morin in U.S. Pat. No. 6,941,896 issued Sep. 13, 2005, provides a tube that scoops into a reservoir, the disclosure of which is incorporated herein by reference. Arceo in U.S. Pat. No. 6,641,188, issued Nov. 4, 2003 provides for a scooper having a bag at an end for articles, the disclosure of which is incorporated herein by reference. Pelley in U.S. Pat. No. 6,361,094, issued Mar. 26, 2002 provides for a crane claw having three jaws. Albert in U.S. Pat. No. 5,540,469, issued Jul. 30, 1996, uses a plastic bag with elastic band for storing articles, the disclosure of which is incorporated herein by reference. Peterson in U.S. Pat. No. 5,649,729 issued Jul. 22, 1997, provides for a single line grab system, the disclosure of which is incorporated herein by reference. Lee in U.S. Pat. No. 5,503,442 issued Apr. 2, 1996 provides for a pair of jaws operating a scooper with continuous bag dispenser, the disclosure of which is incorporated herein by reference. The Lee reference is related to Galvis which in U.S. Pat. No. 5,380,054 issued Jan. 10, 1995, provided for a pair of clamshell with double bell crank assembly, the disclosure of which is incorporated herein by reference. Huegelmeyer in U.S. Pat. No. 5,174,620 issued Dec. 29, 1992 provided for a combination leash and clamshell pick up device, the disclosure of which is incorporated herein by reference. Kohler in U.S. Pat. No. 5,562,319 issued Oct. 8, 1996 provided for articles pick up accomplish by a lasso, the disclosure of which is incorporated herein by reference. Numerous tools have been invented and marketed to solve this problem. Unfortunately, none seem to offer easy operation and satisfactory results.

### SUMMARY OF THE INVENTION

Generally, a pick up tool has a handle assembly having a trigger connected to a pull rod. The trigger has a trigger engaged position, and a trigger disengaged position. In the trigger engaged position the trigger pushes the pull rod down, and in the trigger disengaged position, the trigger pulls the pull rod up. A hollow main shaft is mounted to the handle assembly, and the pull rod is housed within the main shaft. A bell housing is mounted to the handle assembly, and the bell housing has an upper bell portion, a middle bell portion, a lower bell portion and a bell flange. A plurality of fingers are connected at a common joint within the bell housing, and the plurality of fingers have an extended position and a retracted position. A liner assembly includes a liner bag having a closed end and a liner rim. A retraction mechanism includes a retraction spring biasing the plurality of fingers into a retracted position.

The plurality of fingers have at least three fingers, and each finger has an upper finger segment connected to an intermediate finger segment. The intermediate finger segment is connected to a lower finger segment, and the lower finger segment is connected at a knuckle to a fingertip segment. The intermediate finger segment angles outward, wherein the fingertip segment angles inward. The plurality of fingers and the bell housing act in concert such that the angle of the fingers and their length are sized according to a diameter and a depth of the bell housing to determine a range of opening and closing motion. In the retracted position, the plurality of fingers retract within and are stored within the bell housing.

The single handed operated tool for picking up loose debris has a handle assembly which preferably comprises the main shaft, a trigger, a handle mounting a finger grip and an optional release catch. The handle assembly has a handle configured with a pistol grip having a squeeze trigger mechanism, an extension tube, and a bell housing. The three or more articulated fingers are retained inside the bell housing when the tool is in its closed position. The articulated fingers extend outward and open beyond the bell housing when the tool is in extended position. The main shaft is preferably a hollow tube. The bell housing can be constructed as a frame having openings but is preferably of solid wall as shown in the drawings.

The bell housing holds the articulated fingers. Each finger has an upper finger segment that is held within an upper bell portion, and an intermediate finger segment that is held within the middle bell portion. The upper bell portion flares outward to the middle bell portion and extends to a maximum circumference at a bell flange. The intermediate finger segment is connected to the upper finger segment at an upper end and is connected to a lower finger segment at a lower end. The lower finger segment terminates at a fingertip segment in the lower bell portion. The upper finger segment is generally parallel to each other, then the intermediate finger segment extends outward from the upper finger segment, and then the lower finger segment extends outward from the intermediate finger segment. Finally, the fingertip segment extends inward from the lower finger segment. In closed position where the articulated fingers become retracted within the bell housing, the lower bell portion, houses the fingertip segment, lower finger segment, and knuckle which connects the lower finger segment to the fingertip segment.

A common joint has connection for pivotally connecting a plurality of articulated fingers. The common joint provides a swivel so that the articulated fingers can open and close. The articulated fingers are flexible and have a neutral position which is the open position. A spring biases the articulated fingers into closed position by pulling up the assembly into the bell housing. When the spring is installed, it is preferably installed around a pull rod. The spring has a lower end that abuts an internal the lower portion of the main shaft to offer retracting force to pull the common joint upward. The spring can be a compression helical spring. During actual use, a liner assembly can be formed as a plastic liner bag with elastic band or a tie at the open end that can be installed to the bell housing if the user squeezes, the pistol grip to open the finger grip. An elastic band can be disposed at the liner rim for closing the bag. The retraction mechanism acts as a rocker-slider mechanism which pushes the actuating shaft inside the extension tube forward, causing the fingers to extend and spread open beyond the opening of the bell housing. The user can push the closed end of the plastic liner bag into the opening and the closed end of the liner assembly can be held between upper finger segments, then flip the open end of the bag over the rim of the bell housing and affix the liner rim to the neck of the bell housing. Once the user releases the squeeze trigger, and the tool is ready to use. In ready use position, the tool is in closed position or retracted position where the upper finger segments continue to cooperate for retaining the closed end and where the liner rim is held around the rim of the bell housing. The bag has a capacity for holding articles.

When a user wants to pick up an object, the user squeezes the pistol grip to deploy the fingers into extended grabbing position. The user then releases the squeeze trigger. The debris is scooped up and securely held inside the plastic liner bag that is now inside the bell housing. The user can close the bag by pulling the plastic liner rim off of the bell housing. The plastic liner bag portion can be secured at the open end liner rim by using a tie or other securing methods such as tape or a zipper. After securing, the articles can be carried in the tool safely until ready for disposal. Disposal requires the user of to squeeze the trigger again and let the plastic liner bag drop into the dumpster. The tool does not touch the articles under normal operating conditions and the tool is easy to clean and sanitize if required.

The plastic liner bag serves as a positive encapsulation method to hold the loose articles in an intact configuration. The articulated fingers are made of springy plastic or metal so that they are resiliently deformable. The articulated fingers constrain the plastic bag within a defined space. The fingers open and close as they reciprocate and travel up and down the bell housing following the motion of the actuating shaft inside the extension tube. The bell housing holds the fingers, plastic liner bag, and articles in its cavity when the tool is in the closed position. A tie can be formed as part of the liner bag such as in a loop around the liner rim. The tie can be circular in cross section. The liner rim can be partially rolled up so that the tie is concealed or otherwise wrapped up until used is required.

Optional features include a detent quick-release rail installed on top of the pistol grip so that a detachable retractable leash housing can be attached to the tool. This enables the dog walker to carry the leash and the tool together with only one hand as by the finger grip, or the leash grip handle. Also, an accessories clip is preferably mounted on the extension tube enabling the user to carry a flashlight, pepper spay, or any other accessories conveniently. A leash assembly has a leash grip handle and a leash grip opening. The direction of the leash can be controlled by the user since the leash assembly is attached at a leash connector which attaches to a handle mounting. A release catch provides a release of the leash connector from the handle mounting. An accessories clip may hold an accessory such as a flashlight.

### BRIEF DESCRIPTION OF THE DRAWINGS

FIG. 1 is a side view of the present invention in extended position next to a view of the present invention in retracted position and having a leash and light option.

FIG. 2 is an exploded view of the present invention showing attachment of the liner.

FIG. 3 is a diagram of the opening and closing of the finger assembly.

FIG. 4 is a diagram of the opening and closing of the finger assembly inside the bell housing.

FIG. 5 is a diagram of the leash attachment connection to the tool handle.

The following call out list of elements is helpful in determining the nature of the drawings:
20 Handle Assembly
22 Main Shaft
24 Trigger
26 Handle Mounting
28 Finger Grip
29 Release Catch
30 Bell Housing
31 Upper Finger Segment
32 Upper Bell Portion
33 Middle Bell Portion
34 Bell Flange
35 Intermediate Finger Segment
36 Lower Bell Portion
37 Finger Tip Segment
38 Lower Finger Segment
39 Knuckle
40 Liner Assembly
42 Closed End of Bag
44 Bag
46 Liner Rim
50 Retraction Mechanism
52 Retraction Spring
54 Common Joint
56 Pull Rod
60 Leash Assembly
62 Leash Grip Handle
63 Leash
64 Leash Connector
68 Leash Grip Opening
81 Accessories Clip
88 Accessory

### DETAILED DESCRIPTION OF THE PREFERRED EMBODIMENT

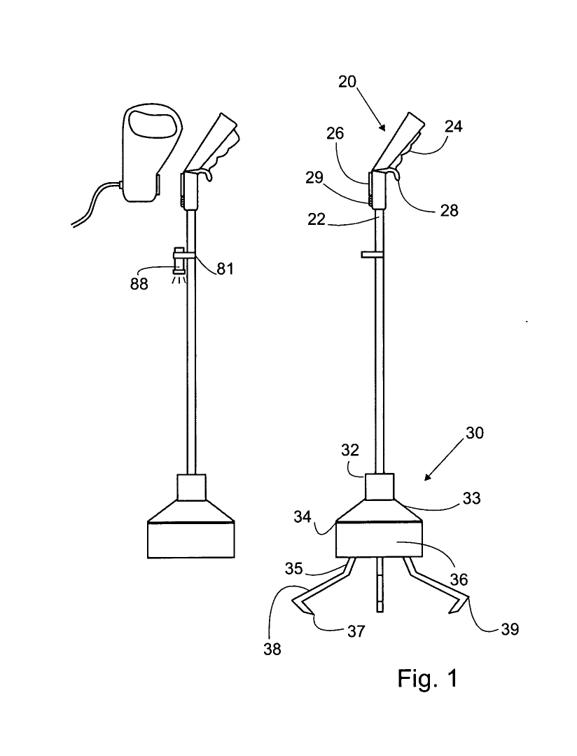

A single handed operated tool for picking up loose debris has a handle assembly 20 which preferably comprises the main shaft 22, a trigger 24, a handle mounting 26 a finger grip 28 and an optional release catch 29, FIG. 1. The handle assembly has a handle configured with a pistol grip having a squeeze trigger mechanism, an extension tube, and a bell housing. The three or more articulated fingers are retained inside the bell housing when the tool is in its closed position. The articulated fingers extend outward and open beyond the bell housing 30 when the tool is in extended position. The main shaft 22 is preferably a hollow tube.

The bell housing 30 holds the articulated fingers. Each finger has an upper finger segment 31 that is held within an upper bell portion 32, and an intermediate finger segment that is held within the middle bell portion 33. The upper bell portion 32 flares outward to the middle Bell portion 33 and extends to a maximum circumference at a bell flange 34. The intermediate finger segment 35 is connected to the upper finger segment 31 at an upper end and is connected to a lower finger segment 38 at a lower end. The lower finger segment 38 terminates at a fingertip segment 37 in the lower bell portion 36. The upper finger segment 31 is generally parallel to each other, then the intermediate finger segment 35 extends outward from the upper finger segment 31, and then the lower finger segment 38 extends outward from the intermediate finger segment 35. Finally, the fingertip segment 37 extends inward from the lower finger segment 38. In closed position where the articulated fingers become retracted within the bell housing 30, the lower bell portion 36, houses the fingertip segment 37, lower finger segment 38, and knuckle 39 which connects the lower finger segment 38 to the fingertip segment 37. The segments of the fingers are preferably straight portions that are not mechanically jointed to other segments of the fingers, but are rather formed from a single piece of plastic that is bendable.

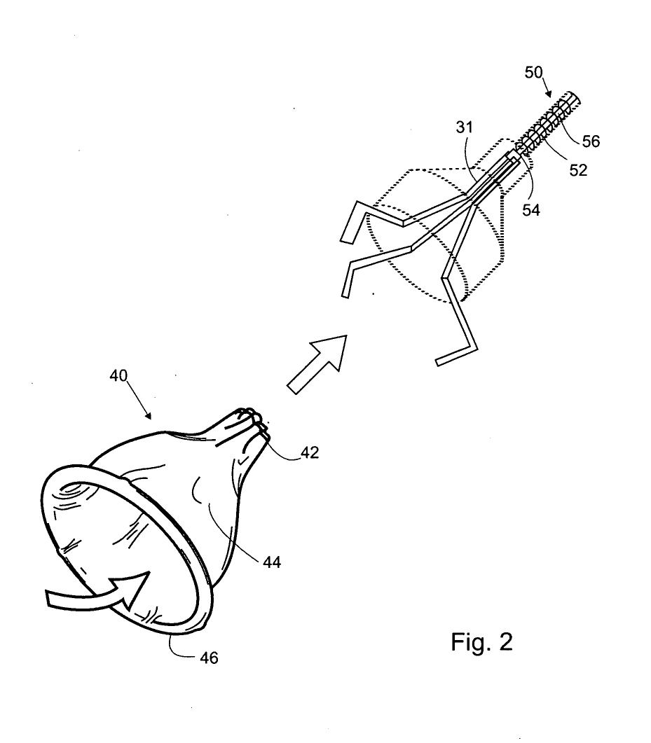

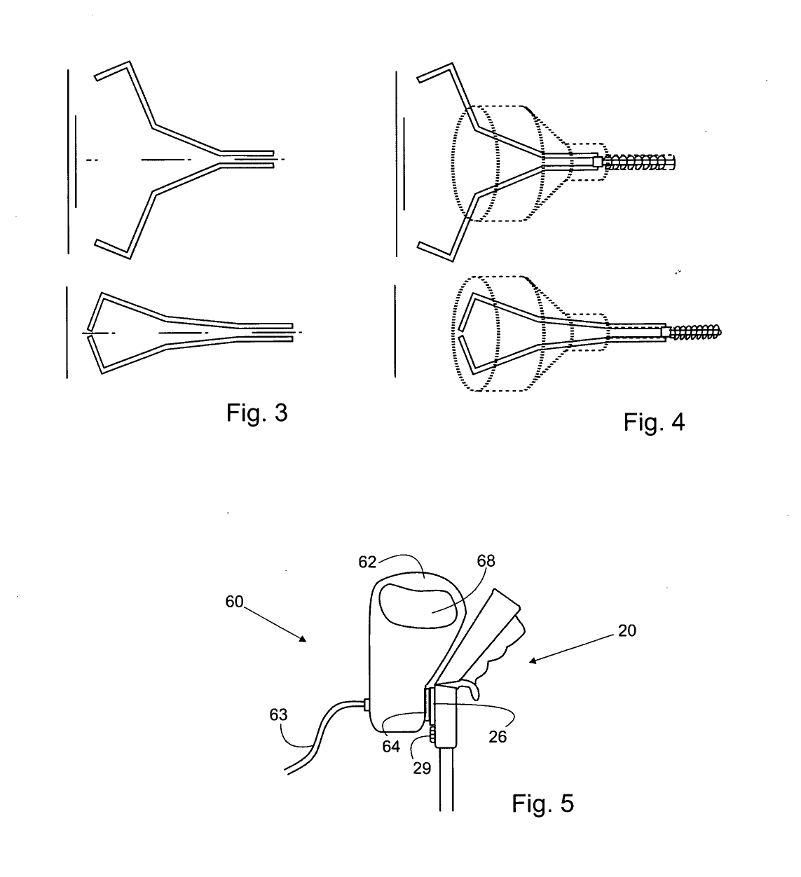

A common joint 54 has connection for pivotally connecting a plurality of articulated fingers, FIG. 2, 3, 4. The common joint 54 provides a swivel so that the articulated fingers can open and close. The articulated fingers are flexible and have a neutral position which is the open position. A spring 52 biases the articulated fingers into closed position by pulling up the assembly into the bell housing. When the spring is installed, it is preferably installed around a pull rod 56. The spring has a lower end that abuts an internal the lower portion of the main shaft 22 to offer retracting force to pull the common joint upward. The spring can be a compression helical spring.

During actual use, a liner assembly 40 can be formed as a plastic liner bag 44 with elastic band or a tie at the open end that can be installed to the bell housing if the user squeezes the pistol grip to open the finger grip 28. An elastic band can be disposed at the liner rim 46 for closing the bag. The retraction mechanism 50 acts as a rocker-slider mechanism which pushes the actuating shaft inside the extension tube forward, causing the fingers to extend and spread open beyond the opening of the bell housing. The user can push the closed end of the plastic liner bag into the opening and the closed end of the liner assembly 40 can be held between upper finger segments 31, then flip the open end of the bag over the rim of the bell housing and affix the liner rim 46 to the neck of the bell housing. Once the user releases the squeeze trigger, and the tool is ready to use. In ready use position, the tool is in closed position or retracted position where the upper finger segments 31 continue to cooperate for retaining the closed end 42 and where the liner rim 46 is held around the rim of the bell housing. The bag 44 has a capacity for holding articles. The articulated fingers and bell housing act in concert such that the angle of the fingers are sized according to the diameter and depth of the bell housing to determine the range of opening and closing. The fingers retract within and are stored within the bell housing. The diameter of the bell housing is matched to the finger length and angle to maintain finger retraction within the bell housing.

When a user wants to pick up an object, the user squeezes the pistol grip to deploy the fingers into extended grabbing position. The user then releases the squeeze trigger 24. The debris is scooped up and securely held inside the plastic liner bag that is now inside the bell housing. The user can close the bag by pulling the plastic liner rim 46 off of the bell housing. The plastic liner 40 bag portion 44 can be secured at the open end liner rim 46 by using a tie or other securing methods such as tape or a zipper. After securing, the articles can be carried in the tool safely until ready for disposal. Disposal requires the user of to squeeze the trigger again and let the plastic liner bag drop into the dumpster. The tool does not touch the articles under normal operating conditions and the tool is easy to clean and sanitize if required.

The plastic liner bag serves as a positive encapsulation method to hold the loose articles in an intact configuration. The articulated fingers are made of springy plastic or metal so that they are resiliently deformable. The articulated fingers constrain the plastic bag within a defined space. The fingers open and close as they reciprocate and travel up and down the bell housing following the motion of the actuating shaft inside the extension tube. The bell housing holds the fingers, plastic liner bag, and articles in its cavity when the tool is in the closed position. A tie can be formed as part of the liner bag such as in a loop around the liner rim. The tie can be circular in cross section as shown in FIG. 2. The liner rim can be partially rolled up so that the tie is concealed or otherwise wrapped up until used is required.

Optional features include a detent quick-release rail installed on top of the pistol grip so that a detachable retractable leash housing can be attached to the tool. This enables the dog walker to carry the leash and the tool together with only one hand as by the finger grip 28, or the leash grip handle 62, FIG. 5. Also, an accessories clip is preferably mounted on the extension tube enabling the user to carry a flashlight, pepper spay, or any other accessories conveniently as seen in FIG. 5. A leash assembly 60 has a leash grip handle 62 and a leash grip opening 68. The direction of the leash 63 can be controlled by the user since the leash assembly 60 is attached at a leash connector 64 which attaches to a handle mounting 26. A release catch 29 provides a release of the leash connector 64 from the handle mounting 26. An accessories clip 81 may hold an accessory 88 such as a flashlight.

The accessory clip 81 can have multiple sizes for holding a small flashlight and another accessory such as a pepper spray or additional liner bag held as a reserve. The accessory clip can be double ended for example so as to hold a flashlight at one end, and a pepper spray on the other end. The accessory clip can be triple ended for holding a flashlight, pepper spray and extra bag. The extra bag can be rolled into a small canister approximately the same size as a flashlight.

The foregoing describes the preferred embodiments of the invention. Modifications may be made without departing from the spirit and scope of the invention as set forth in the following claims. The present invention is not limited to the embodiments described above, but encompasses any and all embodiments within the scope of the following claims.

1. A pick up tool comprising:
a. a handle assembly having a trigger connected to a pull rod, wherein the trigger has a trigger engaged position, and a trigger disengaged position, wherein in the trigger engaged position the trigger pushes the pull rod down, wherein in the trigger disengaged position, the trigger pulls the pull rod up;
b. a main shaft mounted to the handle assembly, wherein the pull rod is housed within the main shaft, wherein the main shaft is hollow;
c. a bell housing mounted to the handle assembly, wherein the bell housing has an upper bell portion, a middle bell portion, a lower bell portion and a bell flange;
d. a plurality of fingers connected at a common joint within the bell housing, wherein the plurality of fingers have an extended position and a retracted position;
e. a liner assembly including a liner bag having a closed end and a liner rim;
f. a retraction mechanism including a retraction spring biasing the plurality of fingers into a retracted position, wherein the plurality of fingers and the bell housing act in concert such that the angle of the fingers and their length are sized according to a diameter and a depth of the bell housing to determine a range of opening and closing motion, wherein in the retracted position, the plurality of fingers retract within and are stored within the bell housing.

2. The pick up tool of claim 1, wherein the handle assembly further comprises a finger grip formed as an extension from the handle assembly.

3. The pick up tool of claim 1, further comprising a leash assembly which includes a leash grip handle for controlling a leash, and a leash connector on the leash assembly that connects to a handle mounting on the handle assembly.

4. The pick up tool of claim 1, further comprising an accessories clip for holding an accessory, wherein the accessory is a flashlight.

5. The pick up tool of claim 1, wherein the liner rim further comprises a rolled up portion that is unrolled after a user obtains articles.

6. The pick up tool of claim 1, wherein the handle assembly further comprises a handle mounting for securing a leash assembly, and wherein the handle assembly further comprises a release catch for toggling the handle mounting into a handle mounting released position.

7. The pick up tool of claim 1, wherein the plurality of fingers comprises at least three fingers, wherein each finger has an upper finger segment connected to an intermediate finger segment, wherein the intermediate finger segment is connected to a lower finger segment, wherein the lower finger segment is connected at a knuckle to a fingertip segment.

8. The pick up tool of claim 1, wherein the plurality of fingers comprises at least three fingers, wherein each finger has an upper finger segment connected to an intermediate finger segment, wherein the intermediate finger segment is connected to a lower finger segment, wherein the intermediate finger segment angles outward.

9. The pick up tool of claim 8, wherein the handle assembly further comprises a finger grip formed as an extension from the handle assembly.

10. The pick up tool of claim 8, further comprising a leash assembly which includes a leash grip handle for controlling a leash, and a leash connector on the leash assembly that connects to a handle mounting on the handle assembly.

11. The pick up tool of claim 8, further comprising an accessories clip for holding an accessory, wherein the accessory is a flashlight.

12. The pick up tool of claim 8, wherein the liner rim further comprises a rolled up portion that is unrolled after a user obtains articles.

13. The pick up tool of claim 8, wherein the handle assembly further comprises a handle mounting for securing a leash assembly, and wherein the handle assembly further comprises a release catch for toggling the handle mounting into a handle mounting released position.

14. The pick up tool of claim 1, wherein the plurality of fingers comprises at least three fingers, wherein each finger has an upper finger segment connected to an intermediate finger segment, wherein the intermediate finger segment is connected to a lower finger segment, wherein the lower finger segment is connected at a knuckle to a fingertip segment, wherein the intermediate finger segment angles outward, wherein the fingertip segment angles inward.

15. The pick up tool of claim 14, wherein the handle assembly further comprises a finger grip formed as an extension from the handle assembly.

16. The pick up tool of claim 14, further comprising a leash assembly which includes a leash grip handle for controlling a leash, and a leash connector on the leash assembly that connects to a handle mounting on the handle assembly.

17. The pick up tool of claim 14, further comprising an accessories clip for holding an accessory, wherein the accessory is a flashlight.

18. The pick up tool of claim 14, wherein the liner rim further comprises a rolled up portion that is unrolled after a user obtains articles.

19. The pick up tool of claim 14, wherein the handle assembly further comprises a handle mounting for securing a leash assembly, and wherein the handle assembly further comprises a release catch for toggling the handle mounting into a handle mounting released position.
